(19) United States
(12) Patent Application Publication
(10) Pub. No.: US 2015/0156143 A1
(43) Pub. Date: Jun. 4, 2015

(54) SYSTEM AND METHOD FOR SIDE DISPLAY ON A MULTI-DISPLAY MOBILE DEVICE

(71) Applicant: Nvidia Corporation, Santa Clara, CA (US)

(72) Inventors: Harshal CHOPDE, Pune (IN); Manish TIWARI, Pune (IN); Ankit MENDIRATTA, Pune (IN); Abhishek KUMAR, Pune (IN)

(73) Assignee: Nvidia Corporation, Santa Clara, CA (US)

(21) Appl. No.: 14/094,351

(22) Filed: Dec. 2, 2013

(51) Int. Cl. H04L 12/58; G06F 3/0488; G06F 3/0481

(52) U.S. Cl. CPC H04L 51/04; G06F 3/0481; G06F 3/0488

(57) ABSTRACT

Embodiments of the present invention are operable to display content related to an application using side display screens installed on a multi-display mobile device. As such, embodiments of the present invention can make use of the display surface areas associated with side display screens to render content (e.g., notifications associated with an application) in a power efficient manner. Also, by using separate display buffers for side display screens, embodiments of the present invention can independently render content while other components of the mobile device (e.g., the main display screen) operate within low power mode or “sleep state.” As such, by using side display screen in this fashion, embodiments of the present invention can efficiently utilize the power and computational resources of the mobile device.

### FIELD OF THE INVENTION

Embodiments of the present invention are generally related to the field of mobile devices.

### BACKGROUND OF THE INVENTION

Within the display industry, there is a growing trend in developing high quality display screens for use by mobile devices, such as smartphones, tablets, laptops, etc. Significantly, this trend focuses on technologies which expand on the capabilities of the mobile device's main display screen to render content in a visually pleasing manner. However, by directing their focus on main display screens in this manner, conventional methods of displaying content often ignore the fact that some forms of content may not require the computational and/or power usage costs associated with rendering content on the main display screen. As such, mobile devices displaying content in the manner supported by these methods often unnecessarily consume computational and/or power resources that may be better spent elsewhere.

### SUMMARY OF THE INVENTION

Accordingly, a need exists to address the inefficiencies discussed above. Embodiments of the present invention are operable to display content related to an application using side display screens installed on a mobile device. As such, embodiments of the present invention can make use of the display surface areas associated with side display screens to render content (e.g., notifications associated with an application) in a power efficient manner. Also, by using separate display buffers for side display screens, embodiments of the present invention can independently render content while other components of the mobile device (e.g., the main display screen) operate within a low power mode or “sleep state.” As such, by using one or more side display screens in this fashion, embodiments of the present invention can efficiently utilize the power and computational resources of the mobile device.

More specifically, in one embodiment, the present invention is implemented as a method of displaying content on a multi-display mobile device. The method includes configuring a first side display screen of the mobile device including a plurality of side display screens in which the first side display screen is configured to display first content associated with an application executed on the mobile device, in which the first side display screen includes a display surface area smaller than a main display screen of the mobile device. In one embodiment, the first content is a notification related to the application. In one embodiment, the configuring a first side display screen further includes configuring a second side display screen of the plurality of side display screens to display second content, in which the first content and the second content are associated with different applications operable on the mobile device.

The method also includes configuring a display buffer to generate the first content for display by the first side display screen, in which the display buffer is separate from a main display screen buffer for rendering on the main display screen. In one embodiment, the configuring a display buffer further includes configuring the plurality of side display screens to use separate display buffers, each display buffer of the separate display buffers being associated with a respective side display screen of the plurality of display screens. Furthermore, the method includes displaying the first content on the first side display screen using a first power level, in which the first power level is different than a second power level contemporaneously used by the main display screen.

In one embodiment, the method further includes displaying the first content on the main display screen responsive to a gesture performed by a user to move the first content from the first side display screen to the main display screen. In one embodiment, the method includes removing the main display screen from a sleep state to an active state to display the first content responsive to the gesture. In one embodiment, the first power level is associated with an active power state and the second power level is associated with a sleep state.

In one embodiment, the present invention is implemented as a system for displaying content on a multi-display mobile device. The system includes a display screen configuration module operable to configure a first side display screen of a plurality of side display screens of the mobile device to display first content associated with an application executed on the mobile device, in which the first side display screen includes a display surface area that is less than a main display screen of the mobile device and where the first side display screen is operable to display the first content using a first power level when the main display screen is using a second power level, in which the first power level is different than the second power level used by the main display screen. In one embodiment, the first content is a notification related to the application. In one embodiment, the first power level is associated with an active power state and the second power level is associated with a sleep state.

In one embodiment, the display screen configuration module is further operable to configure a second side display screen of the plurality of side display screens to display second content, in which the first content and the second content are associated with different applications operable on the mobile device. In one embodiment, the display screen configuration module is further operable to configure the first content to be displayed on the main display screen responsive to a gesture performed by a user to move the first content from the first side display screen to the main display screen. In one embodiment, the display screen configuration module is further operable to remove the main display screen from a sleep state to an active state to display the first content responsive to the gesture.

The system also includes a display buffer configuration module operable to configure a display buffer to generate the first content for display by the first side display screen, in which the display buffer is separate from a main display screen buffer used to render content for the main display screen. In one embodiment, the display buffer configuration module is further operable to configure the plurality of side display screens to use separate display buffers, each display buffer of the separate display buffers being associated with a respective side display screen of the plurality of display screens.

In one embodiment, the present invention is implemented as a method of displaying a notification on a multi-display mobile device. The method includes configuring a first side display screen of a plurality of side display screens of the mobile device to display a first notification related to an application executed on the mobile device, in which the first side display screen includes a display surface area that is less than a main display screen of the mobile device. In one embodiment, the method further includes configuring a second side display screen of the plurality of side display screens to display a second notification, in which the first notification and the second notification are associated with different applications operable on the mobile device.

In one embodiment, the application is an electronic mail application and the first notification is related to the electronic mail application detecting a new message event. In one embodiment, the application is a RSS feed application and the first notification is related to the RSS feed application detecting a real-time news update. The method also includes generating the first notification using a display buffer configured for use by the first side display screen, in which the display buffer is separate from a main display screen buffer used to render to the main display screen.

In one embodiment, the generating further includes configuring the plurality of side display screens to use separate display buffers. In one embodiment, the plurality of side display screens circumferentially bound the main display screen of the mobile device. Furthermore, the method includes displaying the first notification on the first side display screen powered to a first power level while the main display screen is powered to a second power level, in which the first power level is different than the second power level used by a main display screen of the mobile device, in which the first power level is associated with an active power state and the second power level is associated with a sleep state.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 is a block diagram of an exemplary mobile computing system capable of displaying content in a power efficient manner using a plurality of side display screens in accordance with embodiments of the present invention.

FIG. 2A depicts an exemplary display screen configuration of a multi-display device in which a side display screen can be configured to display notifications associated with an application in a low powered manner in accordance with embodiments of the present invention.

FIG. 2B depicts an exemplary display screen configuration of a multi-display device in which a main display screen is removed from a sleep state responsive to input received via a side display screen in accordance with embodiments of the present invention.

FIG. 2C is a flow chart of an exemplary method of displaying notifications related to an application in a low powered manner using side display screens of a mobile computing system in accordance with embodiments of the present invention.

FIG. 3A depicts an exemplary display screen configuration of a multi-display device in which a plurality of side display screens can each be configured to display alerts or notifications associated with a respective application in a low powered manner in accordance with embodiments of the present invention.

FIG. 3B is a flow chart of an exemplary method of displaying alerts or notifications associated with a plurality of different applications in a low powered manner using side display screens of a mobile computing system in accordance with embodiments of the present invention.

FIG. 4A depicts an exemplary display screen configuration of a multi-display device in which a side display screen can be configured to primarily render content for an application independent of a main display screen's operational status in accordance with embodiments of the present invention.

FIG. 4B is a flow chart of an exemplary method of using a side display screen of a mobile computing system to primarily display content associated with an application in a low powered manner in accordance with embodiments of the present invention.

### DETAILED DESCRIPTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

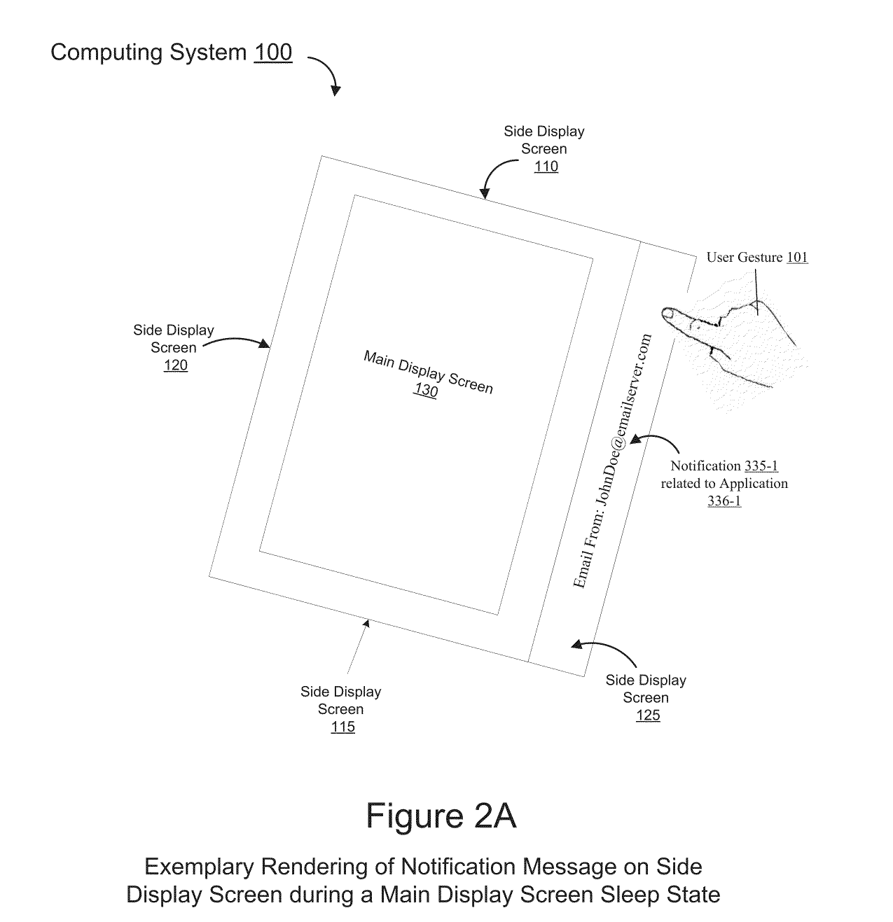

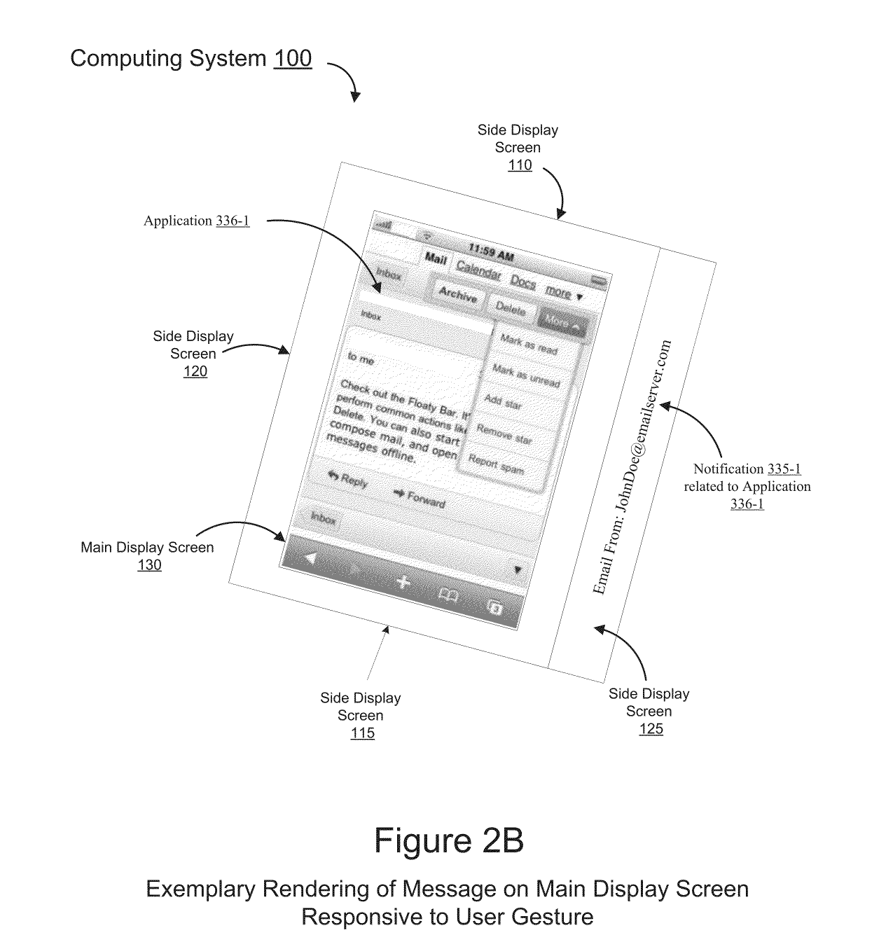

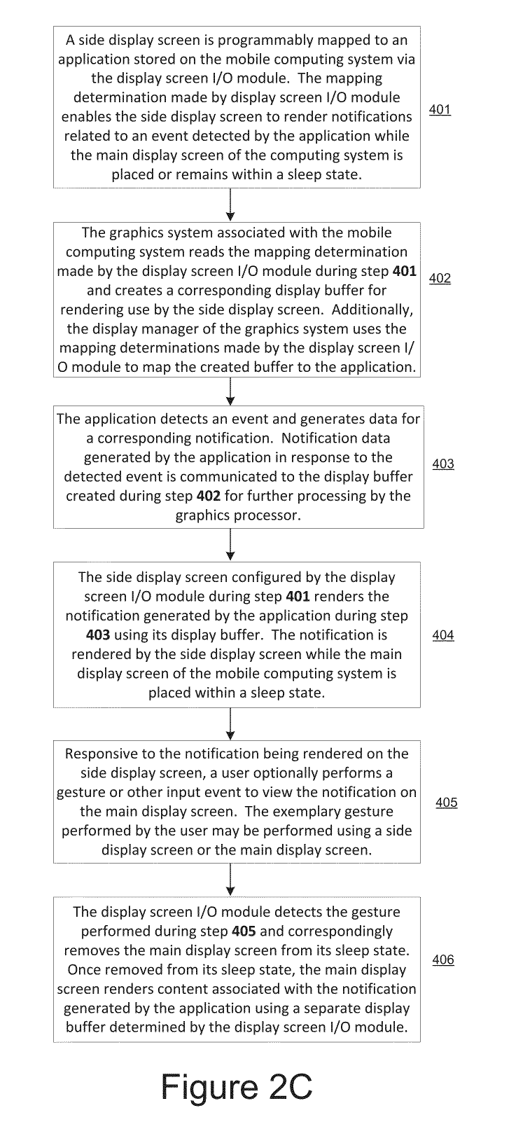

Portions of the detailed description that follow are presented and discussed in terms of a process. Although operations and sequencing thereof are disclosed in a figure herein (e.g., FIGS. 2C, 3B, 4B, etc.) describing the operations of this process, such operations and sequencing are exemplary. Embodiments are well suited to performing various other operations or variations of the operations recited in the flowchart of the figure herein, and in a sequence other than that depicted and described herein.

As used in this application the terms controller, module, system, and the like are intended to refer to a computer-related entity, specifically, either hardware, firmware, a combination of hardware and software, software, or software in execution. For example, a module can be, but is not limited to being, a process running on a processor, an integrated circuit, a subject, an executable, a thread of execution, a program, and or a computer. By way of illustration, both an application running on a computing device and the computing device can be a module. One or more modules can reside within a process and/or thread of execution, and a component can be localized on one computer and/or distributed between two or more computers. In addition, these modules can be executed from various computer readable media having various data structures stored thereon.

### Exemplary Mobile Computing System

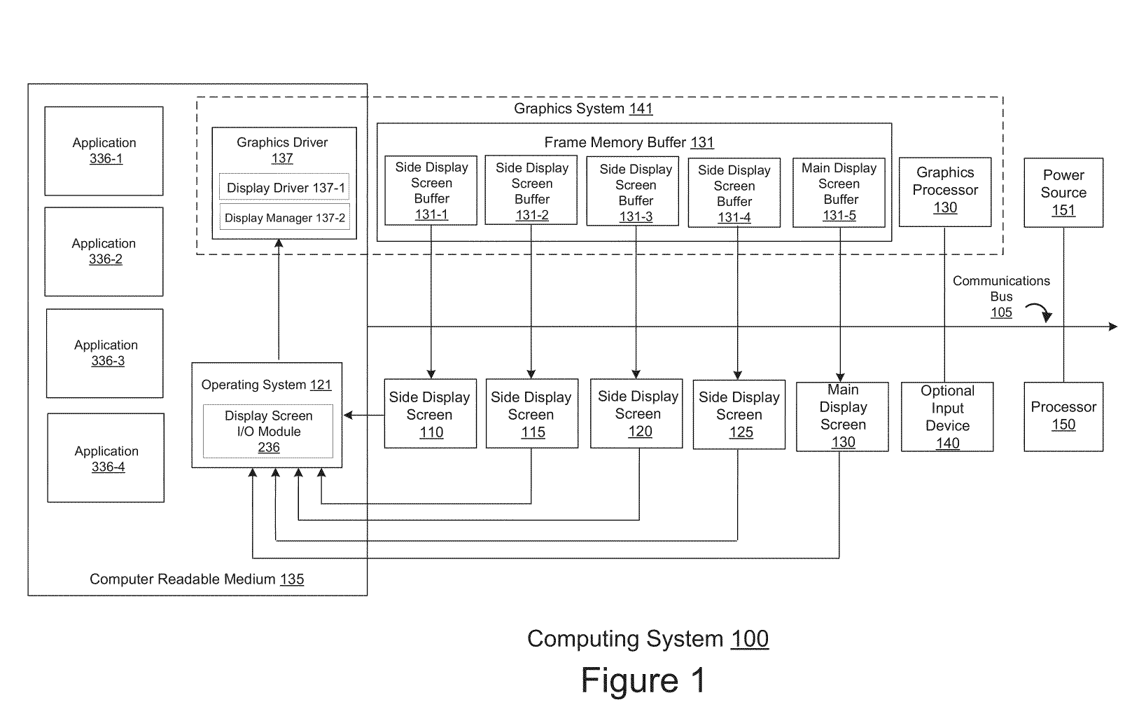

As presented in FIG. 1, an exemplary multi-display computing system 100 upon which embodiments of the present invention may be implemented is depicted. Computing system 100 may be implemented as any mobile electronic device capable of rendering content to a visual display such as a smart phone, cellular phone, tablet, laptop, or the like. Computing system 100 includes communications bus 105, power source 151, processor 150, optional input device 140, main display screen 130, side display screens 110, 115, 120, and 125, computer readable medium 135, and graphics system 141.

Power source 151 is operable to allow computing system 100 to be movable and mobile while operating. As such, power source 151 can be used to supply power to components of computing system 100, including main display screen 130 and side display screens 110, 115, 120, and 125. In one embodiment, computing system 100 may include multiple power sources used for supplying power to individual components of computing system 100. For instance, in one embodiment, main display screen 130 and side display screens 110, 115, 120, and/or 125 may be powered using separate power sources.

Main display screen 130 includes the functionality to render output. Examples of main display screen 130 may include, but are not limited to, a flat panel display such as a liquid crystal display (LCD), a plasma display, or may include cathode ray tube (CRT) monitor, etc. Additionally, in one embodiment, main display screen 130 includes the functionality to receive touch input. For example, main display screen 130 can include a plurality of touch sensitive interconnection points that may be charged during a powered state. The plurality of interconnection points can be spatially arranged in a manner such that each point represents a distinct location (e.g., sampling point) within main display screen 130.

As such, main display screen 130 includes the functionality to detect the performance of touch events based on calculated discharge levels. For instance, when a touch event is performed by an object (e.g., a user's finger) on main display screen 130 during a powered state, the object may make contact with a particular set of sampling points located within main display screen 130. This contact can result in the object providing additional capacitance to the current capacitance levels of those sampling points contacted which may be communicated to operating system 121 (e.g., display screen I/O module 236, discussed infra) for further processing. Furthermore, main display screen 130 is operable to display a graphical user interface capable of allowing a user to interact with various components of computing system 100.

According to one embodiment, computing system 100 contains multiple displays. Side display screens 110, 115, 120, and 125 each include the same functionality as main display screen 130 and can share the same power source as main display screen 130 (e.g., power source 151). In one embodiment, side display screens 110, 115, 120, and 125 can each be installed within the side-housing of computing system 100 (e.g., side panels which circumferentially bound main display screen 130). For instance, side display screens 110 and 115 may be installed on a respective top portion and bottom portion of computing system 100 relative to main display screen 130, while side display screens 120 and 125 may be installed on a respective left portion and right portion of computing system 100 relative to main display screen 130. As such, the screen sizes of side display screens 110, 115, 120, and 125 can each vary based on the physical dimensions and design of computing system 100 (e.g., buttons and/or slots incorporated into the side panels of computing system 100 by a manufacturer). Accordingly, side display screens 110, 115, 120, and/or 125 can each independently perform functions similar to main display screen 130 in a manner that uses less display surface area than main display screen 130. In this fashion, side display screens 110, 115, 120, and/or 125 can each be configured to render output in a manner that also draws a substantially less amount of power compared to main display screen 130.

Furthermore, side display screens 110, 115, 120, and/or 125 can be configured (e.g., via display screen I/O module 236, discussed infra) to operate while other components of computing system 100 (e.g., main display screen 130) operate within a low power mode or “sleep state.” For instance, in one embodiment, main display screen 130 can be configured as a primary means of displaying content associated with an application to a user, whereas side display screens 110, 115, 120, and/or 125 can be configured to display supplementary content (e.g., notifications, etc.) related to the same application. As such, side display screens 110, 115, 120, and/or 125 can each be configured to display notifications that alert the user to the occurrence of an event related to the execution of application 336-1 that may be of interest to the user. In this manner, notifications rendered by side display screens 110, 115, 120, and/or 125 can include content that explicitly or implicitly alerts of an application event.

In one embodiment, if the notification is of interest to the user, the user can perform an action or gesture using main display screen 130 and/or side display screens 110, 115, 120, and/or 125 to view content related to the notification on main display screen 130. As such, side display screens 110, 115, 120, and/or 125 can each be configured to display notifications in a manner that draws very little power from power source 151 while other components of computing system 100 (e.g., main display screen 130) operate within a low power mode or sleep state. Furthermore, gestures used by a user to engage side display screens 110, 115, 120, and/or 125 may be performed using fingers or instruments (e.g., stylus).

According to one embodiment, side display screens 110, 115, 120, and/or 125 can each be configured to display notifications that alert the user of the occurrence of an event related to different applications. For instance, applications 336-1, 336-2, 336-3, and 336-4 may be separate applications that are each configured to primarily display content on main display screen 130 (e.g., via display screen I/O module 236, discussed infra). As such, side display screens 110, 115, 120, and/or 125 can be configured to separately display notifications associated with applications 336-1, 336-2, 336-3, and 336-4, respectively. Furthermore, according to one embodiment, side display screens 110, 115, 120, and/or 125 can be configured to primarily render output themselves for applications that do not require substantial graphical computation by computing system 100. Accordingly, side display screens 110, 115, 120, and/or 125 can be used separately and for different purposes.

Display screen I/O module 236 includes the functionality to map an application to a respective side display screen. Also, display screen I/O module 236 includes the functionality to communicate values received from side display screens 110, 115, 120, 125 and/or main display screen 130 to a respective application executed from memory resident on computing system 100. For example, input received by display screen I/O module 236 from side display screens 110, 115, 120, 125 and/or main display screen 130 may be gathered and communicated to applications 336-1, 336-2, 336-3, 336-4, respectively. As such, graphics system 141 may be operable to render output for applications 336-1, 336-2, 336-3, and 336-4 on each side display screen based on input received via display screen I/O module 236.

Display screen I/O module 236 also includes functionality to move content displayed on side display screens 110, 115, 120, and/or 125 to main display screen 130 responsive to commands received from a user (e.g., through touch input or gesture input) via side display screens 110, 115, 120, and/or 125 to move the content. In this manner, display screen I/O module 236 can be configured to remove main display screen 130 from a low power mode or sleep state to an active state or display state in order to display content previously displayed on side display screens 110, 115, 120, and/or 125.

According to one embodiment, graphics system 141 comprises graphics driver 137, frame memory buffer 131, and graphics processor 130. Graphics driver 137 includes the functionality to configure graphics processor 130. In one embodiment, graphics driver 137 comprises display driver 137-1 and display manager 137-2. As illustrated in FIG. 1, side display screens 110, 115, 120, 125 and/or main display screen 130 can each have its own memory buffer (e.g., static buffer) created for processing output images for display within their respective display screens (e.g., side display screen buffers 131-1, 131-2, 131-3, 131-4 and main display screen buffer 131-5). Based on the input received from display screen I/O module 236, operating system 121 and/or graphics processor 130 may create additional memory buffers within frame memory buffer 131 so that graphics processor 130 may process pixel data independently for each respective display screen. In another embodiment, frame memory buffer 131 and/or other memory may be part of computer readable medium 135 which may be shared with processor 150 and/or graphics processor 130.

In one embodiment, display manager 137-2 may be operable to read input stored by display screen I/O module 236 and map an application to a display buffer created. For example, based on the mapping determinations made by display manager 137-2, data generated by an application in response to user input stored by display screen I/O module 236 may be sent to a respective display buffer (e.g., side display screen buffers 131-1, 131-2, 131-3, 131-4 and main display screen buffer 131-5) for further processing by graphics processor 130.

Within a display buffer created for a particular display screen, graphics processor 130 may process pixel data for output images associated with an application mapped to that display screen using rendering commands provided by the application. In one embodiment, computing system 100 may include additional physical graphics processors, each configured similarly to graphics processor 130. These additional graphics processors may be configured to operate in parallel with graphics processor 130 to simultaneously generate pixel data for different portions of an output image, or to simultaneously generate pixel data for different output images. Furthermore, display driver 137-1 may be operable to send control signals to each buffer created to transmit their respective output for display within their respective display screens.

Depending on the specific configuration and type of computing system environment, computer readable storage medium 135 may be volatile (such as RAM), non-volatile (such as ROM, flash memory, etc.) or some combination of the two. Portions of computer readable storage medium 135 when executed facilitate efficient execution of memory operations or requests for groups of threads. Also, optional input device 140 may include optional input device(s) such as a keyboard, mouse, pen, voice input device, touch input device, remote control, camera, etc.

Although specific components of computing system 100 are disclosed in FIG. 1, it should be appreciated that such components are examples. That is, embodiments of the present invention are well suited to having various other components or variations of the components recited in computing system 100 (e.g., more side display screens, less side display screens, etc.). It is appreciated that the components in computing system 100 may operate with other components other than those presented, and that not all of the components of computing system 100 may be required to achieve the goals of computing system 100.

### A Method of Display Content Using a Pluarlity of Side-Display Screens

FIG. 2A depicts an exemplary display screen configuration of multi-display computing system 100 in which a side display screen can be configured to display notifications associated with an application in a low powered manner in accordance with embodiments of the present invention. As depicted in FIG. 2A, computing system 100 can be placed in a “sleep state” in which some components of computing system 100 (e.g., main display screen 130) operate in a low power mode. While operating within this sleep state, computing system 100 can periodically execute background processes associated with an application (e.g., application 336-1). For instance, application 336-1 may be an electronic mail (“email”) application, for instance, that periodically determines if a new message has been received.

As illustrated in FIG. 2A, responsive to a detection of a new message event associated with application 336-1, side display screen 125 may be configured to use a display buffer determined by display manager 137-1 (e.g., side display screen buffers 131-1, 131-2, 131-3, 131-4, etc.) to correspondingly render notification 335-1. Notification 335-1 includes content that is related to application 336-1 and can explicitly or implicitly alert the user to the occurrence of the event related to application 336-1 (e.g., new message received by application 336-1). For instance, as illustrated in FIG. 2A, notification 335-1 may include the email address of the sender sending the message. In one embodiment, notification 335-1 may include a portion of the new message received. As such, side display screen 125 can display portions of the new message that fit within its physical dimensions. In one embodiment, side display screen 125 may include an LED display that lights up responsive to new notifications.

Responsive to notification 335-1 being displayed on side display screen 125, the user may perform a gesture (e.g., user gesture 101) on side display screen 125 which can correspondingly remove main display screen 130 from a sleep state to an active or powered state and allow it to render the new message received by application 336-1. Thus, computing system 100 may capable of conserving both power and computational resources by rendering certain content (e.g., notifications) related to an application within the display surface area of side display screen 125 instead of main display screen 130.

FIG. 2B depicts an exemplary display screen configuration of multi-display computing system 100 in which a user can selectively view interesting or content rich messages via a main display screen based on input received through a side display screen in accordance with embodiments of the present invention. As depicted in FIG. 2B, main display screen 130 can be restored to an active state responsive to a gesture performed by a user on side display screen 125 during a previous sleep state (see FIG. 2A). As such, main display screen 130 can render primary content associated with application 336-1 using a separate display buffer determined by display manager 137-1 (e.g., main display screen buffer 131-5).

For example, as illustrated in FIG. 2B, primary content rendered on main display screen 130 may include the full textual content of the new message, embedded images included within the message, message folders, etc. As such, main display screen 130 can remain in a low power mode and conserve the computational and/or power resources of computing system 100 while allowing the user to selectively utilize the larger display surface area of main display screen 130 for those notifications that are of interest to the user. In this manner, the user may comfortably view the interesting new message using the display surface area of main display screen 130 (e.g., minimal scrolling, higher resolution associated with main display screen 130 relative to side display screen 125, etc.).

FIG. 2C is a flow chart of an exemplary computer-controlled method of displaying notifications related to an application in a low powered manner using side display screens coupled to a mobile computing system in accordance with embodiments of the present invention.

At step 401, a side display screen is programmably mapped to an application stored on the mobile computing system via the display screen I/O module. The mapping determination made by display screen I/O module enables the side display screen to render notifications related to an event detected by the application while the main display screen of the computing system is placed or remains within a sleep state.

At step 402, the graphics system associated with the mobile computing system reads the mapping determination made by the display screen I/O module during step 401 and creates a corresponding display buffer for rendering use by the side display screen. Additionally, the display manager of the graphics system uses the mapping determinations made by the display screen I/O module to map the created buffer to the application.

At step 403, the application detects an event and generates data for a corresponding notification. Notification data generated by the application in response to the detected event is communicated to the display buffer created during step 402 for further processing by the graphics processor.

At step 404, the side display screen configured by the display screen I/O module during step 401 renders the notification generated by the application during step 403 using its display buffer. The notification is rendered by the side display screen while the main display screen of the mobile computing system is placed within a sleep state.

At step 405, responsive to the notification being rendered on the side display screen, a user optionally performs a gesture or other input event to view the notification on the main display screen. The exemplary gesture performed by the user may be performed using a side display screen or the main display screen.

At step 406, the display screen I/O module detects the gesture performed during step 405 and correspondingly removes the main display screen from its sleep state. Once removed from its sleep state, the main display screen renders content associated with the notification generated by the application using a separate display buffer determined by the display screen I/O module.

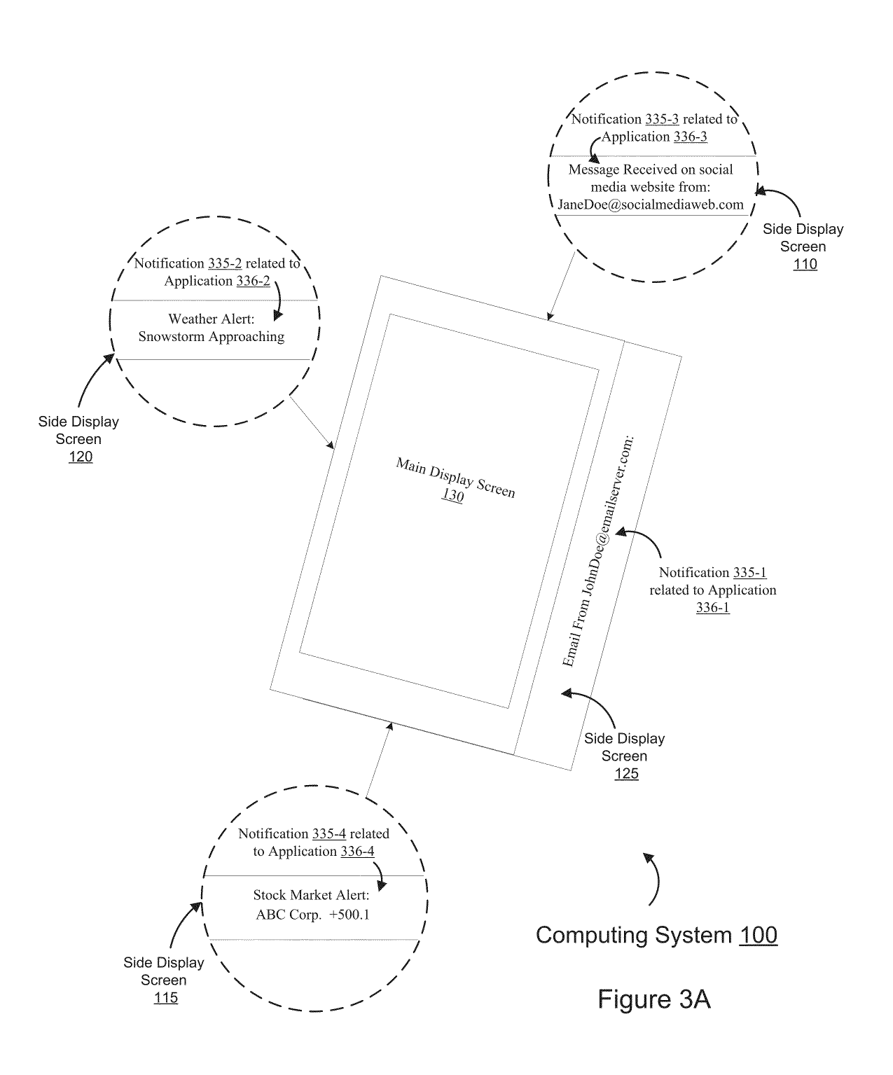

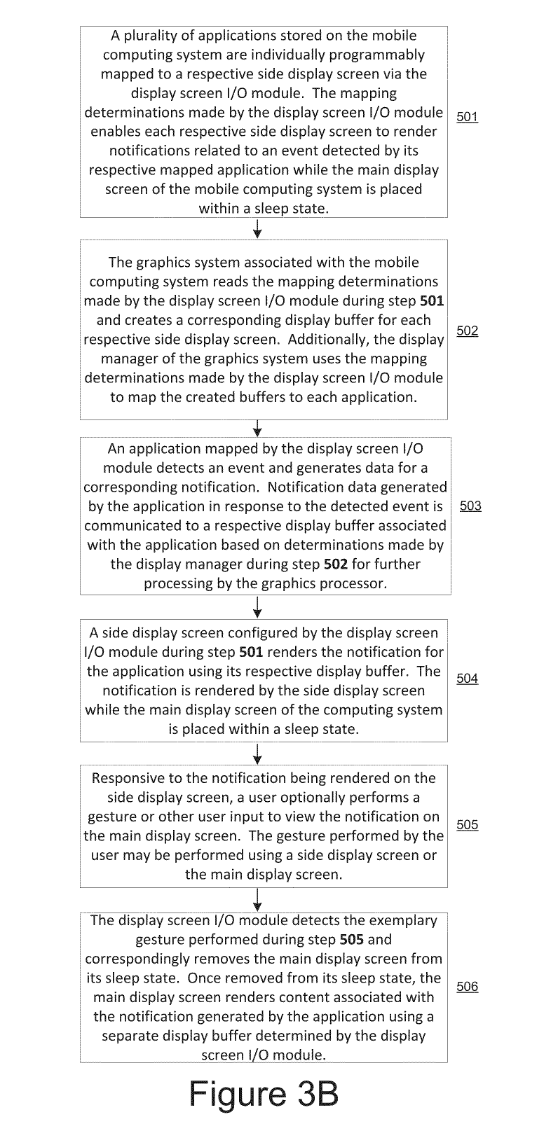

Additionally, as described herein, side display screens 110, 115, 120, and/or 125 can each be configured to display separate notifications related to different applications or different event types. For instance, FIG. 3A depicts an exemplary display screen configuration of computing system 100 in which a plurality of side display screens can each be configured to display alerts or notifications associated with a respective application and/or event category in a low powered manner in accordance with embodiments of the present invention.

As illustrated in FIG. 3A, side display screens 110, 115, 120, and 125 can each be configured independently and thus display notifications in a manner that allows each side display screen to be used for different purposes. For instance, in addition to display screen 125 displaying notifications from application 336-1 (see FIGS. 2A, 2B), side display screen 120 can be separately configured to use a separate display buffer determined by display manager 137-1 to display notifications related to application 336-2 (e.g., notification 335-2) which is a weather application designed to provide emergency weather related information.

Also, side display screen 110 can be configured to use separate display buffer determined by display manager 137-1 to display notifications related to application 336-3 (e.g., notification 335-3), which is a social media application (e.g., Facebook, Twitter, etc.). Additionally, side display screen 115 can be configured to use a separate display buffer determined by display manager 137-1 to display notifications related to application 336-4 (e.g., notification 335-4), which is an application that pulls real-time information from an RSS feed (e.g., stock market information, news information, sports information, etc.).

Although FIG. 3A depicts multiple side display screens configured to render content associated with different, embodiments of the present invention can support configurations in which multiple side display screens are configured to render content associated with a same application. In one embodiment, multiple side display screens can be configured to display different notifications associated with the same application. For example, display screens 110, 115, 120, and 125 can each be configured to display certain types of news associated with application 336-4. For instance, side display screen 110 may be configured to render content relating to real-time sports news; side display screen 115 may be configured to render content relating to real-time stock events; side display screen 120 may be configured to render content relating to real-time social media news; and side display screen 125 may be configured to render content relating to real-time entertainment news.

FIG. 3B is a flow chart of an exemplary method of displaying alerts or notifications associated with a plurality of different applications in a low powered manner using side display screens coupled to a mobile computing system in accordance with embodiments of the present invention.

At step 501, a plurality of applications stored on the mobile computing system are individually programmably mapped to a respective side display screen via the display screen I/O module. The mapping determinations made by the display screen I/O module enables each respective side display screen to render notifications related to an event detected by its respective mapped application while the main display screen of the mobile computing system is placed within a sleep state.

At step 502, the graphics system associated with the mobile computing system reads the mapping determinations made by the display screen I/O module during step 501 and creates a corresponding display buffer for each respective side display screen. Additionally, the display manager of the graphics system uses the mapping determinations made by the display screen I/O module to map the created buffers to each application.

At step 503, an application mapped by the display screen I/O module detects an event and generates data for a corresponding notification. Notification data generated by the application in response to the detected event is communicated to a respective display buffer associated with the application based on determinations made by the display manager during step 502 for further processing by the graphics processor.

At step 504, a side display screen configured by the display screen I/O module during step 501 renders the notification for the application using its respective display buffer. The notification is rendered by the side display screen while the main display screen of the computing system is placed within a sleep state.

At step 505, responsive to the notification being rendered on the side display screen, a user optionally performs a gesture or other user input to view the notification on the main display screen. The gesture performed by the user may be performed using a side display screen or the main display screen.

At step 506, the display screen I/O module detects the exemplary gesture performed during step 505 and correspondingly removes the main display screen from its sleep state. Once removed from its sleep state, the main display screen renders content associated with the notification generated by the application using a separate display buffer determined by the display screen I/O module.

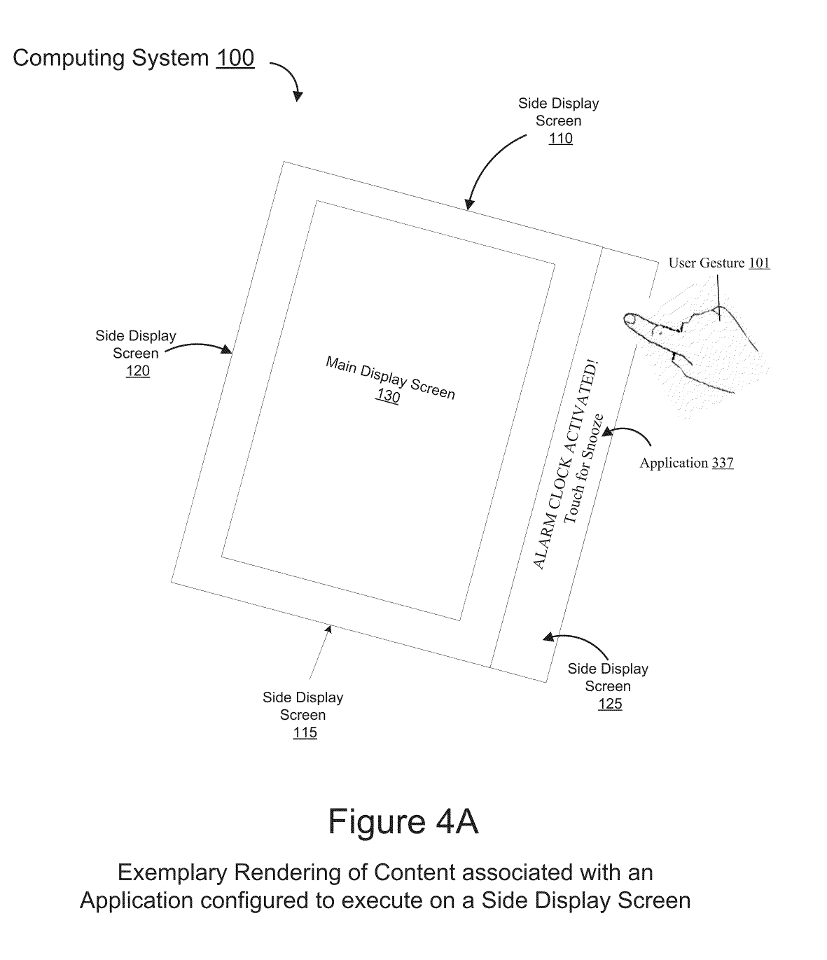

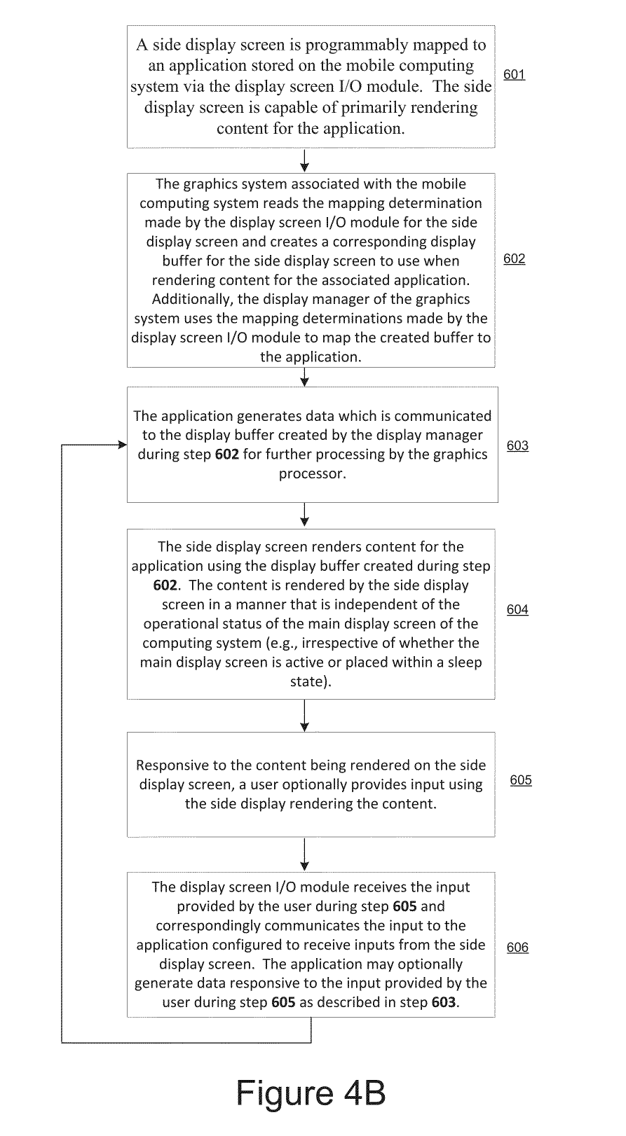

Relative to output typically rendered on main display screen 130, side display screens 110, 115, 120, and/or 125 can each be configured to primarily render output for applications that do not require substantial graphical computation by computing system 100 compared to main display screen 130. For instance, FIG. 4A depicts an exemplary display screen configuration of computing system 100 in which a side display screen can be configured to primarily render content associated with an application independent of a main display screen's operational status in accordance with embodiments of the present invention. As depicted in FIG. 4A, application 337 may be an application (e.g., alarm clock application) configured by display screen I/O module 236 to be primarily executed within side display screen 125. Additionally, application 337 may also be configured by display screen I/O module 236 to receive input through side display screen 125.

As such, display screen I/O module 236 can communicate values received from side display screen 125 to application 337 for further processing. For instance, as illustrated in FIG. 2D, the user may provide touch input (e.g., via user gesture 101) on side display screen 125 responsive to content displayed on side display screen 125 for application 337. Thus, by primarily rendering content for application 337 within the display surface area of side display screen 125 instead of main display screen 130, computing system 100 may capable of conserving both power and computational resources.

Although FIG. 4A depicts one side display screen (e.g., side display screen 125) configured to primarily render content associated with one application (e.g., application 337), embodiments of the present invention can support configurations in which multiple side display screens are configured to primarily render content associated with multiple different applications.

FIG. 4B is a flow chart of an exemplary method of using a side display screen coupled to a multi-display mobile computing system to primarily display content associated with an application in a low powered manner in accordance with embodiments of the present invention.

At step 601, a side display screen is programmably mapped to an application stored on the mobile computing system via the display screen I/O module. The side display screen is capable of primarily rendering content for the application.

At step 602, the graphics system associated with the mobile computing system reads the mapping determination made by the display screen I/O module for the side display screen and creates a corresponding display buffer for the side display screen to use when rendering content for the associated application. Additionally, the display manager of the graphics system uses the mapping determinations made by the display screen I/O module to map the created buffer to the associated application.

At step 603, the application generates data which is communicated to the display buffer created by the display manager during step 602 for further processing by the graphics processor.

At step 604, the side display screen renders content for the application using the display buffer created during step 602. The content is rendered by the side display screen in a manner that is independent of the operational status of the main display screen of the computing system (e.g., irrespective of whether the main display screen is active or placed within a sleep state).

At step 605, responsive to the content being rendered on the side display screen, a user optionally provides input using the side display rendering the content.

At step 606, the display screen I/O module receives the input provided by the user during step 605 and correspondingly communicates the input to the application configured to receive inputs from the side display screen. The application may optionally generate data responsive to the input provided by the user during step 605 as described in step 603.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system.

These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface. Various functions described herein may be provided through a remote desktop environment or any other cloud-based computing environment.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

What is claimed is:

1. A method of displaying content on a mobile device, said method comprising:
configuring a first side display screen of said mobile device comprising a plurality of side display screens, wherein said first side display screen is configured to display first content associated with an application executed on said mobile device, wherein said first side display screen comprises a display surface area smaller than a main display screen of said mobile device;
configuring a display buffer to generate said first content for display by said first side display screen, wherein said display buffer is separate from a main display screen buffer for rendering on said main display screen; and
displaying said first content on said first side display screen using a first power level, wherein said first power level is different than a second power level contemporaneously used by said main display screen.

2. The method as described in claim 1, wherein said configuring a first side display screen further comprises configuring a second side display screen of said plurality of side display screens to display second content, wherein said first content and said second content are associated with different applications operable on said mobile device.

3. The method as described in claim 1, wherein said configuring a display buffer further comprises configuring said plurality of side display screens to use separate display buffers, each display buffer of said separate display buffers being associated with a respective side display screen of said plurality of display screens.

4. The method as described in claim 1, further comprising displaying said first content on said main display screen responsive to a gesture performed by a user to move said first content from said first side display screen to said main display screen.

5. The method as described in claim 4, further comprising removing said main display screen from a sleep state to an active state to display said first content responsive to said gesture.

6. The method as described in claim 1, wherein said first content is a notification related to said application.

7. The method as described in claim 1, wherein said first power level is associated with an active power state and said second power level is associated with a sleep state.

8. A system for displaying content on a mobile device, said system comprising:
a display screen configuration module operable to configure a first side display screen of a plurality of side display screens of said mobile device to display first content associated with an application executed on said mobile device, wherein said first side display screen comprises a display surface area that is less than a main display screen of said mobile device and wherein said first side display screen is operable to display said first content using a first power level wherein said main display screen is using a second power level, wherein said first power level is different than said second power level used by said main display screen; and
a display buffer configuration module operable to configure a display buffer to generate said first content for display by said first side display screen, wherein said display buffer is separate from a main display screen buffer used to render content for said main display screen.

9. The system as described in claim 8, wherein said display screen configuration module is further operable to configure a second side display screen of said plurality of side display screens to display second content, wherein said first content and said second content are associated with different applications operable on said mobile device.

10. The system as described in claim 8, wherein said display buffer configuration module is further operable to configure said plurality of side display screens to use separate display buffers, each display buffer of said separate display buffers being associated with a respective side display screen of said plurality of display screens.

11. The system as described in claim 8, wherein said display screen configuration module is further operable to configure said first content to be displayed on said main display screen responsive to a gesture performed by a user to move said first content from said first side display screen to said main display screen.

12. The system as described in claim 8, wherein said display screen configuration module is further operable to remove said main display screen from a sleep state to an active state to display said first content responsive to said gesture.

13. The system as described in claim 8, wherein said first content is a notification related to said application.

14. The system as described in claim 8, wherein said first power level is associated with an active power state and said second power level is associated with a sleep state.

15. A method of displaying a notification on a mobile device, said method comprising:
configuring a first side display screen of a plurality of side display screens of said mobile device to display a first notification related to an application executed on said mobile device, wherein said first side display screen comprises a display surface area that is less than a main display screen of said mobile device;
generating said first notification using a display buffer configured for use by said first side display screen, wherein said display buffer is separate from a main display screen buffer used to render to said main display screen; and
displaying said first notification on said first side display screen powered to a first power level while said main display screen is powered to a second power level, wherein said first power level is different than said second power level used by said main display screen of said mobile device, wherein said first power level is associated with an active power state and said second power level is associated with a sleep state.

16. The method as described in claim 15, further comprising configuring a second side display screen of said plurality of side display screens to display a second notification, wherein said first notification and said second notification are associated with different applications operable on said mobile device.

17. The method as described in claim 15, wherein said generating further comprises configuring said plurality of side display screens to use separate display buffers.

18. The method as described in claim 15, wherein said application is an electronic mail application and said first notification is related to said electronic mail application detecting a new message event.

19. The method as described in claim 15, wherein said application is a RSS feed application and said first notification is related to said RSS feed application detecting a real-time news update.

20. The method as described in claim 17, wherein said plurality of side display screens circumferentially bound said main display screen of said mobile device.
